(19) United States
(12) Patent Application Publication
(10) Pub. No.: US 2025/0306848 A1
(43) Pub. Date: Oct. 2, 2025

(54) Smart Hearing Aid System with Bone Conducting Headphones

(71) Applicants: Shijun Sun, Redmond, WA (US); Daniel Sun, Redmond, WA (US)

(72) Inventors: Shijun Sun, Redmond, WA (US); Daniel Sun, Redmond, WA (US)

(21) Appl. No.: 18/623,154

(22) Filed: Apr. 1, 2024

(51) Int. Cl. G06F 3/16; G10L 17/02; G10L 25/78; H04R 1/10

(52) U.S. Cl. CPC G06F 3/165; H04R 1/1008; H04R 1/1041; G10L 17/02; G10L 25/78; H04R 2460/13

(57) ABSTRACT

Hearing loss, a common challenge associated with aging, affects a significant portion of the global aging population. The proposed Babblefish system aims to address this by offering smart and yet affordable solutions through bone-conducting headphones. The Babblefish system not only amplifies sounds, but also records voices and allows user interactions with recorded voices. The system architecture allows flexible configurations, incl. a baseline setup to leverage existing Blue Tooth headphones in the market through mobile apps, a Model X headset to allow basic on-device Babblefish controls, and a Model Y headset to allow more advanced on-device Babblefish experiences for paraphrasing, summarization, and translations. In addition, the Babblefish system also provides privacy safeguards for bystanders through an LED indicator during active recording, and circular memory buffers within the system.

### BACKGROUND

With an aging population across the globe, it has become increasingly critical for the whole of society to empower elderly individuals to navigate the challenges of everyday life with confidence, independence, and dignity. It's therefore a commitment for Babblefish Technologies to develop intuitive, personalized, and ML/AI powered accessibility products, so we could support every senior to participate in and contribute to the communities and live life to the fullest.

Gradual hearing loss (e.g. presbycusis) is one of the typical physical challenges due to aging. Within the US, approximately 15.5% of adults aged 20 and older, which translates to around 44.1 million people, experience some level of hearing loss. Among individuals aged 65 and older, 31.1% have hearing loss, and this percentage increases to 40.3% for adults aged 75 and older.

The U.S. hearing aids market has been growing steadily. As of 2022, the U.S. hearing aids market was valued at USD 3.87 billion. By 2030, it is estimated that the U.S. hearing aids market will reach an impressive USD 7.01 billion. Although the current hearing aid technologies have been well established, at Babblefish Technologies, we believe there is significant room to improve based on the latest innovations in ML/AI and hardware technologies.

The main function of a conventional hearing aid is to amplify sounds, helping people with hearing impairment to better perceive and understand speech and other environmental sounds.
Hearing aids come in various styles and sizes, including behind-the-ear (BTE), in-the-ear (ITE), in-the-canal (ITC), and completely-in-the-canal (CIC), among others. The choice of hearing aid style depends on factors such as the degree of hearing loss, personal preferences, and cosmetic considerations.
Modern hearing aids often feature advanced digital signal processing (DSP) technology, which allows for customization and optimization of sound based on individual hearing needs and preferences. They may also include features such as noise reduction, feedback cancellation, directional microphones, and connectivity options to stream audio from smartphones, TVs, or other devices.

However, due to potential complexity of the existing hearing aid technology, the cost of the devices is still a burden to many individuals with hearing impairment. In the US, the average price for one hearing aid is around USD 2,300, with the cost per ear commonly in the range from USD 1,000 to 4,000. Since most people require a pair of hearing aids, the total cost would be double of this range. In addition, follow-up appointments, maintenance, and/or batteries could add further on top of the initial costs.

The goal of the proposed Babblefish system is to provide additional hearing aid solutions that are more intuitive and affordable (i.e. less than USD 100 per unit for both ears). The name of Babblefish Technologies is inspired by a fictional creature from Douglas Adams' The Hitchhiker's Guide to the Galaxy, the Babel fish. If you stick a Babel fish in your ear, it would decode any speech patterns you hear and feed the result directly into your brainwave matrix, so that you could instantly understand anything said to you in any language.

In reality, the proposed Babblefish system will primarily focus on bone conducting headphones (rather than in-the-ear), which has been a well established technology on its own. Bone conducting headphones have been widespread globally, with a global market of USD 653.5 million in 2021 and projected to reach USD 5.79 billion by 2031. A major contributor to the growth will be the increasing prevalence of hearing disorders. Technically, bone conducting headphones bypass the need for eardrums to transmit sound. For people with damaged eardrums, this technology provides an alternative pathway for sound perception. Individuals with conductive hearing loss and even damaged ear canals can all potentially benefit from bone conducting headphones. In addition, there is no surgery required for people to test and use bone conducting headphones.

### SUMMARY

The proposed Babblefish system provides smart hearing aid solutions beyond simply amplifying incoming voice data during real-time conversations.

The system allows the user to record other people's voices in a very recent conversation, and then allows the user to replay that back with various volume and speed settings. The system also allows advanced interactions to paraphrase or summarize the voice content, and/or translate the voice content to the user's preferred language option.

As part of the privacy protection for bystanders in the conversation, the system will show a visual indicator during active recording, and always manage the recording of voice within internal circular buffers, and then will always purge the data within a small amount of time (e.g. 5 minutes). All system operations will stay within the system, i.e. without dependency on internet connections.

The proposed Babblefish system allows various configurations, including a baseline setup to leverage existing Bluetooth headphones in the market through mobile apps, a Model X headset to allow basic on-device Babblefish controls, and a Model Y headset to allow more advanced on-device Babblefish experiences for paraphrasing, summarization, and translations.

### BRIEF DESCRIPTION OF DRAWINGS

FIG. 1. High level illustration of the Babblefish system architecture.

FIG. 2. High level illustration of the Babblefish baseline configuration for what sub components are on device and what are on the app.

FIG. 3. High level illustration of the Babblefish Model X configuration for what sub components are on device and what are on the app.

FIG. 4. High level illustration of the Babblefish Model Y configuration for what sub components are on device and what are on the app.

FIG. 5. Illustration of user control buttons and major components on the Babblefish Model X/Y devices.

### DETAILED DESCRIPTIONS

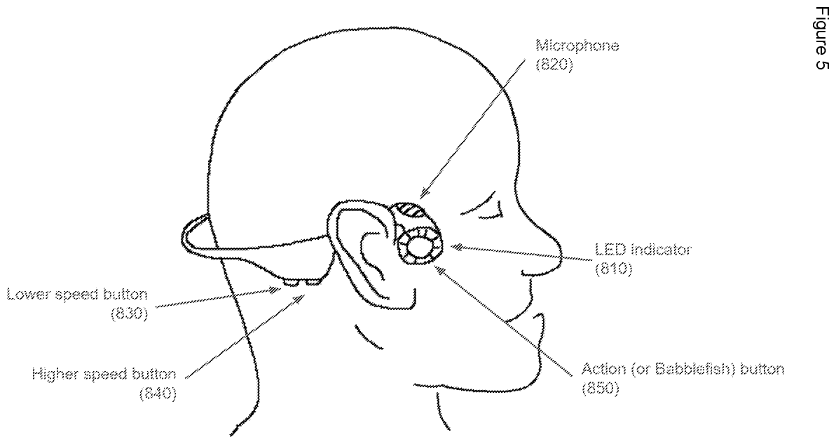

A Babblefish system consists of a bone conducting headphone and a mobile app. It can be activated by the user through the user settings in the Babblefish app or a corresponding button on the device (FIG. 5).

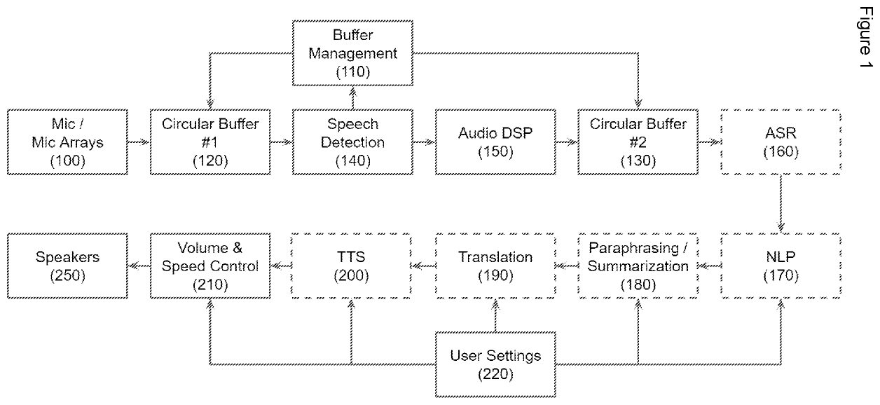

When the Babblefish system is activated, the microphone or the mic-array (100) of the headset is turned on. As illustrated in FIG. 1, the audio signals are being continuously captured and stored into a circular memory buffer #1 (120). The data in this circular buffer is used by the speech detector (140) to detect whether there is any active voice being directed to the system by the user or another person, respectively. The size of the circular buffer (120) is on the order of a few seconds, i.e. sufficient for the speech detector to make a positive decision and trigger the next step in the system, yet not enough to track a complete conversation meaningfully. By design, the data in the circular buffer (120) will always be overridden by newer signals in several seconds.

When the speech detector (140) detects there is an active speech activity either by the user or another person, the speech detector will trigger audio DSP (150) and active recording of the voice data in a circular buffer #2 (130), and provide corresponding metadata to the buffer management module (110). The corresponding data in the circular buffer #1 will be continuously carried to the audio DSP pipeline and the circular buffer #2. Circular buffer #2 has a capacity to temporarily store the voice data continuously for up to several minutes, e.g. 5 minutes.

The audio DSP module (150) is able to process the audio data through beamforming, noise reduction, equalization, echo cancellation, etc. to produce cleaner data and stored them in the circular buffer #2 for further operations.

The buffer management module (110) is responsible for tracking system timestamps of the data in the buffer to indicate when each recent speech segment starts, ends, and is also responsible for tracking whether each voice segment is by the user or by another person. The buffer management module (110) will also reset both circular buffers at new system activation, i.e. purging all data in the memory buffers.

If the speech is not from the user, the processed data is played through the system speakers (250) in real time at normal speed largely in sync with the actual speech, i.e. at 1.0× speed, with a minimum system latency, i.e. <10 ms. This is basically the dataflow for the conventional hearing aid functionality.

When there is a user command to replay the previous speech segment (by a person speaking to the user) at a certain speed (e.g. 0.75×) and with a certain system volume (e.g. 0.95), the volume and speed control module (210) will take action accordingly based on the data in the circular buffer #2 (130) to deliver the updated audio samples to the system speakers (250).

When advanced experiences (e.g. paraphrasing, summarization, translation) are enabled either through user settings (220) and user voice commands, the ASR module (160), i.e. the automatic speech recognition module, will be invoked to convert the audio data into text, and natural language processing (NLP) module (170) will be invoked to process and understand the speech text and take further actions accordingly. As examples of further operations,
When the user setting and user command is to paraphrase the previous speech content, the Paraphrasing and Summarization module (180) will be invoked in the pipeline.
When the user setting and user command is to translate the previous speech content to a specific language option, the translation module (190) will be invoked.
When new speech text is produced, the TTS module (200) will be invoked to convert the text to speech audio for the next playback step.

The user commands we mentioned above can be issued as user voice commands, or using on-device manual Action button (850) that we will introduce in FIG. 5.

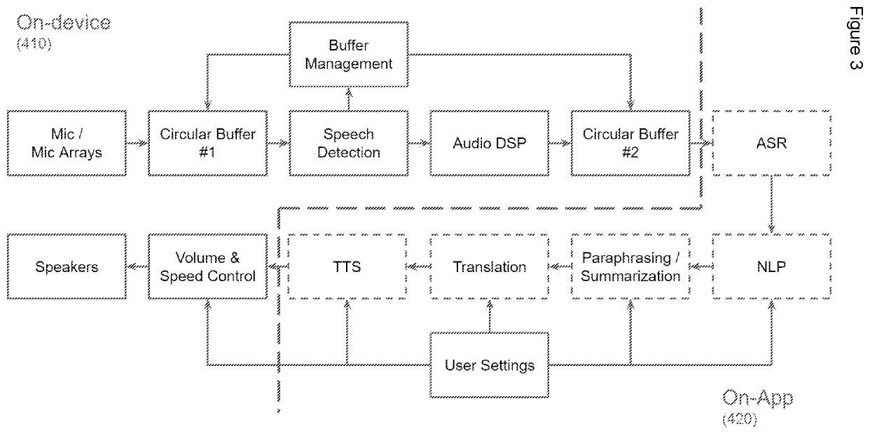

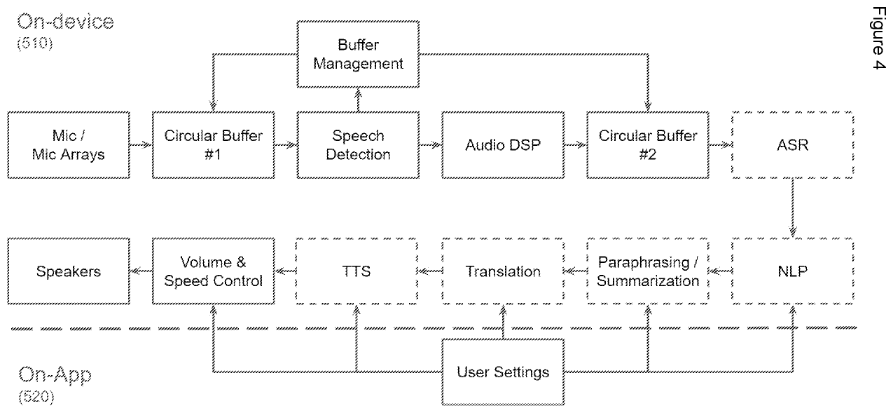

The user settings (220) for the system include but are not limited to the following: default system volume, default playback speed, default language option for advanced experiences, volume control during playback, speed control during playback, pause/resume during playback, advanced experience options, and a default action through the Action (or Babblefish) button either in the Babblefish app, or on the Babblefish devices (850, FIG. 5), as well as OTA update options for Babblefish device configurations in FIGS. 3-4.

Both real-time audio play and the on-demand/user-triggered audio playback are through the system speakers (250). Again, the real-time audio play is preferably at a 1.0× speed to stay in sync with the facial impression and action of the person speaking to the user.

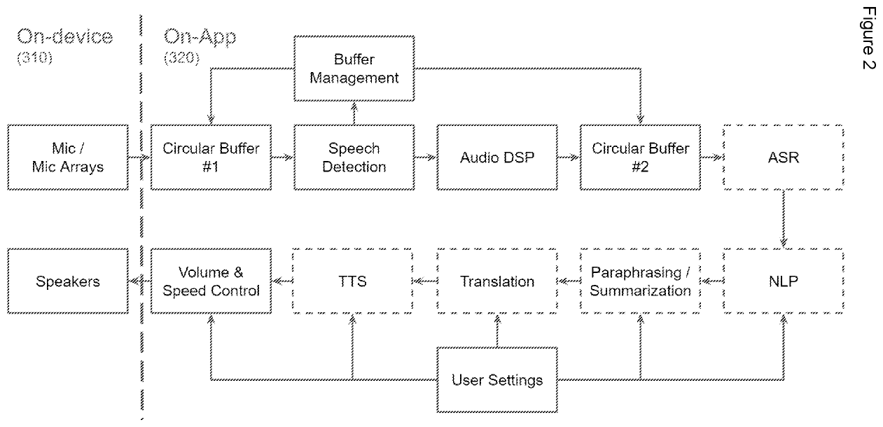

The system architecture allows plenty of flexibility in configurations, as a tradeoff between the quality of experience and the potential cost of the system. For example,
FIG. 2 is an illustration of a Babblefish baseline configuration. The system leverages existing bluetooth devices for microphones and speakers as the on-device modules (310). All other functional modules are built in the Babblefish app space (320). The division between on-device and on-app is represented by the vertical dashed line in FIG. 2.
FIG. 3 is an illustration of Babblefish Model X. All basic system modules are on-device (410), except advanced Al components (i.e. ASR, NLP, paraphrasing and summarization, translation, and TTS) and user settings are still kept in the app space (420).
FIG. 4 is an illustration of Babblefish Model Y. All system modules are on-device (510), with only the user settings still on the app (520).

FIG. 5 is an illustration of Babblefish Model X/Y devices being worn by a person, showing only the right ear of the person's head.
The device will have an explicit LED indicator (810), which will be turned on when the system is in active recording. The LED indicator can serve other purposes as well which will not be covered in details here.
The device will have microphones (820) on both sides of the devices.
The device will have buttons to control playback speed, to slow down (830) or to speed up (840). The buttons can also be configured through user settings for volume up and volume down.
The same LED indicator also serves as a button for user Actions. It's called the Action or the Babblefish button, which allows quick action by the user with only a single click. A factory-reset system default of the Babblefish button is to replay the previous speech segment by a person speaking to the user. The default action can be modified through the user settings in the mobile app, for example, to allow smart paraphrases.
The Action button, when clicked during a playback session, will pause and resume the playback.
Meanwhile, press-and-hold the Babblefish button will turn on/off the device. Tuning on the device will automatically put the device into an activation mode, i.e. ready for all Babblefish hearing aid functionality.

As a quick summary for the privacy handling. The Babblefish system would rely on an LED indicator on the headset to inform bystanders that there is an active recording session. Meanwhile, recorded audio data will never leave the Babblefish system, and will be purged from the circular buffers within a few minutes of the recording.

Note: The focus of the writing is on the basic concept. There are many possible system level optimizations and more advanced ML/AI experiences, which will not be included at this moment.

1. A hearing aid system that records audio data during conversation between a user and other people, and then allows the user to interact with the recorded audio data.

2. The hearing aid system in claim #1 has a speech detection module to determine when the system should start active recording, and when to stop.

3. The speech detection module in claim #2 has capability to detect whether each voice data segment is by the user or another person.

4. The hearing aid system in claim #1 has a replay capability to play back recorded audio data based on user command.

5. The replay capability in claim #4 allows adjustable playback speed based on user controls.

6. The user controls in claim #5 for playback speed adjustment can be hardware buttons explicitly on a headset device.

7. The replay capability in claim #4 allows adjustable playback volume based on user controls.

8. The replay capability in claim #4 allows voice data to be paraphrased before playback.

9. The replay capability in claim #4 allows voice data to be summarized before playback.

10. The replay capability in claim #4 allows voice data to be translated to a preferred language before playback.

11. The hearing aid system in claim #1 provides a visual indicator on a headset device during active recording.

12. The hearing aid system in claim #1 provides an action button to trigger a default action when the button is clicked.

13. The default action in claim #12 is to play back recorded audio data.

14. The default action in claim #12 can be modified through a set of user settings.

15. The action button in claim #12 is a button on a headset device.

16. The action button in claim #15 can be used to pause or resume playback during a playback session.

17. The action button in claim #15 can be used to turn on or turn off the hearing aid system.

18. The button on the headset device in claim #15 is combined with the visual indicator in claim #11.

19. The hearing aid system in claim #1 manages recorded data within system internal memories, and deletes all data within a predetermined amount of time.
